(19) United States
(12) Patent Application Publication
(10) Pub. No.: US 2019/0258460 A1
(43) Pub. Date: Aug. 22, 2019

(54) METHOD AND SYSTEM FOR GENERATING A SOFTWARE COMPONENT

(71) Applicant: dSPACE digital signal processing and control engineering GmbH, Paderbom (DE)

(72) Inventor: Dennis SCHLACHTER, Muenchen (DE)

(73) Assignee: dSPACE digital signal processing and control engineering GmbH, Paderborn (DE)

(21) Appl. No.: 15/901,933

(22) Filed: Feb. 22, 2018

(51) Int. Cl. G06F 8/35; G06F 8/34; G06F 8/41

(52) U.S. Cl. CPC G06F 8/35; G06F 8/41; G06F 8/34

(57) ABSTRACT

A method for generating a software component for an electronic control unit by a processor on a computer system, the software on the computer system comprising an architecture definition tool and a behavior-modeling tool, the architecture definition tool being adapted to define an architecture of the software component, architecture information comprising a declaration of one or more subcomponents and one or more interfaces, the architecture definition tool additionally being adapted to export and import architecture information, the behavior modeling tool being adapted to generate source code for the software component based on a function model comprising a plurality of interconnected blocks, the behavior-modeling tool additionally being adapted to import and export architecture information, wherein the behavior-modeling tool creates or updates a model framework for the function model based on the architecture information.

### BACKGROUND OF THE INVENTION

### Field of the Invention

The present invention relates to methods and computer systems for automatically generating source code from block diagrams. In particular, the invention in an embodiment relates to generating a binary executable file for a software component using an architecture definition tool and a behavior-modeling tool.

### Description of the Background Art

Electronic control units (ECUs) are ubiquitous especially in automotive applications. Generally, they may contain a processor, in particular a microcontroller, one or more sensor interfaces and one or more circuits to control an actuator. Current parameters of a physical process are typically determined using the signals of the one or more sensors connected to the sensor interfaces. Based on a predefined control strategy, the processor may control the one or more circuits to apply the actuators in order to influence the physical process. In an example, an ECU may be used to perform anti-lock braking, with a sensor measuring the wheel velocity and a magnetic valve reducing the pressure in the corresponding wheel brakes.

Increasing memory resources and computational speed of modern microcontrollers allow for increasingly complex control strategies as well as for running multiple programs on a single ECU. In order to manage this increased complexity, the AUTOSAR (AUTomotive Open System ARchitecture) development partnership defined a software framework for the development of ECU software (detailed information can be found at www.autosar.org). Prior to implementing the actual control strategy or desired behavior, an architecture of the software is specified. The architecture comprises software components, subcomponents (runnable entities) and interfaces of software components. Messaging between different software components may be performed via a runtime environment (RTE) adapted to the defined architecture. For instance, the software architecture may comply with the AUTOSAR classic platform standard version 4.3.0 of 30.11.2016. An exemplary architecture definition tool is System Desk of dSPACE.

Control strategies are typically developed using block diagrams in a behavior-modeling tool that may comprise a technical computing environment (TCE) allowing for tracing the temporal behavior of a physical system described by blocks in the block diagram. The document “Production Quality Code Generation from Simulink Block Diagrams”, Proceedings of the 1999 IEEE International Symposium on Computer Aided Control System Design, Kohala-Coast, Hawai'i, USA, by H. Hanselmann et al. describes a behavior-modeling tool, TargetLink of dSPACE, that allows for automatically generating production code based on a block diagram containing one or more blocks that specify the behavior of a program, in particular implementing a desired control strategy.

In the workflow of generating a software component for an ECU, the architecture definition tool and the behavior-modeling tool need to exchange information. This is generally done using dedicated XML files, for example, these files conform to a formal exchange format defined by the AUTOSAR collaboration (ARXML files). When the architecture has been defined, at least one ARXML file is generated and imported in the behavior-modeling tool. A model framework may be generated based on the imported information. Once the desired control strategy has been modeled, source code for the software component can be generated by the behavior-modeling tool. Because parts of the information resulting from a code generation are also pertinent to the architecture definition tool, the behavior-modeling tool also is adapted to export ARXML files. During the development process, a roundtrip of ARXML files may occur multiple times between the architecture definition tool and the behavior-modeling tool (and vice versa).

Complex software tools and container formats have been designed in order to manage these roundtrips. For example, U.S. Pat. No. 9,360,853, which is incorporated herein by reference, discloses a computer management system for the creation of an ECU software.

In the conventional art, however, it is cumbersome to determine if any relevant changes have occurred to the architecture during the implementation of the behavior model. Particular difficulties arise in the case of large development projects that involve many developers implementing a plurality of different software components that need to be reintegrated after detailed implementation.

Thus, improved methods for generating a software component are desired, in particular a fast and easy way to determine relevant changes to the architecture defined in an ARXML file.

### SUMMARY OF THE INVENTION

It is therefore an object of the present invention to provide a method and a computer system for generating ECU software.

In an exemplary embodiment of the invention, a computer-implemented method for generating a software component for an electronic control unit is provided. The method may be executed by, for example, at least one processor in a computer system, the software on the computer system comprising an architecture definition tool and a behavior-modeling tool. The architecture definition tool is adapted to define an architecture of the software component, architecture information comprising a declaration of one or more subcomponents and one or more interfaces, the architecture definition tool additionally being adapted to export and import architecture information. The behavior modeling tool is adapted to generate source code for the software component based on a function model comprising a plurality of interconnected blocks, the behavior-modeling tool additionally being adapted to import and export architecture information, wherein the behavior-modeling tool creates or updates a model framework for the function model based on the architecture information. The inventive method comprises: receiving architecture information from the behavior-modeling tool; exporting architecture information from the architecture definition tool in a first auxiliary file, calculating a first checksum for the first auxiliary file; saving the first checksum; receiving a request to check for changes in the architecture; exporting architecture information from the architecture definition tool in a second auxiliary file; calculating a second checksum for the auxiliary file, and comparing the second checksum to the first checksum.

In case of a difference between the second checksum and the first checksum the method comprises indicating the presence of differences to the user and/or transferring architecture information from the architecture definition tool to the behavior-modeling tool and generating code in the behavior-modeling tool.

Advantageously, the inventive method provides a mechanism that allows for a fast detection of changes to the software architecture. Because the architecture information is exported specifically for calculating the checksum, the relevant elements can be chosen based on predefined settings in the export mechanism. The export can comprise a recursive export of all elements that are referenced in the software component. By only following specific references, such as references to a specific kind of element or references of a particular kind, the export mechanism allows for selecting which information to retain as relevant information. The presence of changes in the architecture can be indicated to the user, e.g. via a graphical user interface. Additionally or alternatively, the inventive method may comprise automatically performing a new roundtrip in order to generate code based on the changed architecture definition. The auxiliary files may be deleted after calculating a checksum.

Transferring architecture information from the architecture definition tool to the behavior-modeling tool can comprise creating an XML file, in particular an AUTOSAR ARXML file. The AUTOSAR ARXML file may be a standalone file or it may be part of a container file comprising additional information. XML is a widespread text-based format, which can be handled fast and efficiently.

Receiving architecture information from the behavior-modeling tool can comprise receiving an XML file, in particular an AUTOSAR ARXML file, the received XML file comprising a section with variable information, i.e. information on variables, such as data type, scaling or range. In particular, variable information need not have been defined before but may be determined during code generation in the behavior-modeling tool. Further information that may have been added or changed in the behavior-modeling tool are the name of an interface input port, the name of a runnable entity and/or the name of a parameter or global variable.

In an embodiment of the invention, exporting the architecture information from the architecture definition tool comprises filtering the architecture information. Filtering may be carried out with a predefined fixed filter or by executing filter scripts. This allows for a more fine-grained determination of relevant information. Parameters of an element that do not pertain to the architecture, such as a unique but arbitrarily chosen identification number (UUID), may be filtered out.

In an embodiment of the invention, filtering the architecture information comprises receiving a selection of elements to ignore. Alternatively, only a subset of the elements may be chosen; the checksum may for instance be calculated not for the entire software component but only for a part, such as one of multiple subcomponents in the software component. Subcomponents may be a runnable entity, task, function or any other separable set of elements.

For example, the steps of exporting the architecture information from the architecture definition tool in a first auxiliary file and calculating a current checksum for the first auxiliary file are performed at least after each transfer of architecture information from the behavior-modeling tool to the architecture definition tool. Recalculating the checksum takes in account new implementation information produced during code generation.

For example, the inventive method comprises receiving a command by a user via a user to perform a version check. This allows for recalculating the checksum any desired time; in particular, it allows for a dedicated calculation of the checksum before integrating the software component in the executable binary for the ECU. Alternatively or additionally, the check for changes may be triggered by a script running on the host computer that detects the fulfillment of predefined check conditions; a check condition may e.g. be fulfilled, when a predefined time span has passed or a separately stored model parameter, such as version information from a version management system, has changed.

When a system definition of the electronic control unit comprises multiple software components, a checksum can be calculated separately for each software component, so that when checking for changes in the architecture separate comparisons to previous checksums are made for each software component. Because the checksum is calculated and saved for each software component, the user may switch between checking the entire system definition and checking a single software component in the architecture definition. Separate checksums also allow for incremental upgrades, leaving a first software component and the corresponding elements unchanged and only updating a second software component and/or the corresponding elements. This concept could also be applied to different subcomponents of a software component, thus allowing for a more fine-grained incremental code generation.

An aspect of the invention also concerns a non-transitory computer readable medium containing instructions that, when executed by a microprocessor of a computer system, cause the computer system to carry out the inventive method.

In an embodiment of the invention, a computer system is provided which comprises a processor, a random access memory, a graphics controller connected to a display, a serial interface connected to at least one human input device, and a nonvolatile memory, in particular a hard disk or a solid-state disk. The nonvolatile memory comprises instructions that, when executed by the processor, cause the computer system to carry out the inventive method. The processor may be a general-purpose microprocessor that is customary used as the central processing unit of a personal computer or it may comprise one or a plurality of processing elements adapted for carrying out specific calculations, such as a graphics-processing unit. In alternative embodiments of the invention, the processor may be replaced or complemented by a programmable logic device, such as a field-programmable gate array, which is configured to provide a defined set of operations and/or may comprise an IP core microprocessor.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an exemplary diagram of a computer system;

FIG. 2 is an exemplary diagram of software on a computer system;

FIG. 3 is an exemplary diagram of a method for generating production code from a function model;

FIG. 4 is an exemplary diagram of a method for creating the firmware of an ECU;

FIG. 5 is an exemplary function model of a software component; and

FIG. 6 is an exemplary flowchart for detecting changes to the design of a software component.

### DETAILED DESCRIPTION

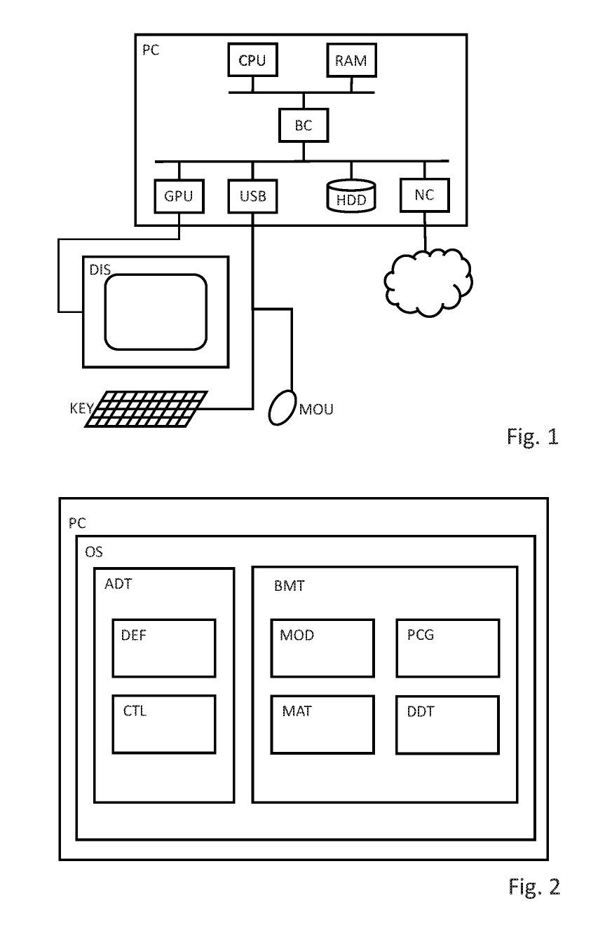

FIG. 1 illustrates an exemplary embodiment of a computer system. The shown embodiment comprises a host computer PC with a display DIS and human interface devices such as a keyboard KEY and a mouse MOU.

The host computer PC comprises at least one processor CPU with one or multiple cores, a random access memory RAM and a number of devices connected to a local bus (such as PCI Express), which exchanges data with the CPU via a bus controller BC. The devices comprise e.g. a graphics-processing unit GPU for driving the display, a controller USB for attaching peripherals, a non-volatile memory HDD such as a hard disk or a solid-state disk, and a network interface NC. The non-volatile memory can comprise instructions that, when executed by one or more cores of the processor CPU, cause the computer system to carry out a method according to one of the claims.

In an embodiment of the invention, suggested by a stylized cloud in the figure, the host computer may comprise one or more servers comprising one or more processing elements, the servers being connected to a client comprising a display device and an input device via a network. Thus, the technical computing environment may be executed partially or completely on a remote server, such as in a cloud computing setup. A personal computer may be used as a client comprising a display device and an input device via a network. Alternatively, a graphical user interface of the technical computing environment may be displayed on a portable computing device, in particular a portable computing device with a touch screen interface.

FIG. 2 displays an exemplary embodiment of the software being executed on the computer system, which may be realized as a host computer PC with a standard microprocessor that runs a standard operating system OS such as Microsoft Windows or a Linux distribution. On the host computer PC, an architecture definition tool ADT and a behavior-modeling tool BMT are installed.

The architecture definition tool ADT comprises a definition environment DEF. The definition environment DEF can comprise a graphical user interface for defining and modifying the software architecture. In addition, it may comprise a user interface for defining a hardware architecture comprising one or multiple ECUs and/or a user interface for deploying different elements of the software architecture on the ECUs of the hardware architecture.

Additionally, the architecture definition tool comprises a control tool CTL that allows for importing and/or exporting one or more elements of the software architecture, in particular an entire software component definition, and allows for calculating a checksum based on an XML file comprising the different elements to be included in the calculation. The control tool may also comprise a facility for applying filters, in particular by running filter scripts, during or after an export of a selected software component.

The behavior-modeling tool BMT may be based on a technical computing environment (such as MATLAB/Simulink of The MathWorks) that comprises a plurality of software components such as a model editor MOD for displaying and modifying block diagrams and/or a script interpreter MAT that is adapted for carrying out calculations or modifying data. Additionally, a simulation engine for executing block diagrams may be part of the BMT. The BMT comprises a production code generator PCG that is adapted to produce production code from a model; further, it comprises a data definition tool DDT. The expression that a software component is comprised in the BMT is intended to encompass the case that the software component uses a specific mechanism of the BMT such as an application-programming interface in order to exchange data and/or instructions with other software components in the BMT. For example, a software component may be realized as or comprise an add-on such as a toolbox or a block library for the model editor MOD.

The model editor MOD may provide a graphical user interface for creating and modifying block diagrams that can describe the temporal behavior of a dynamic system. Additionally, blocks adapted for describing finite states and conditions for transitions between states may be used to model the dynamic system. A block may describe an atomic operation, such as an arithmetic calculation or a logic expression, or it may represent a subsystem that is described in more detail by an additional or partial block diagram in a subordinate hierarchical level. This need not imply that the partial block diagram is stored in a separate file, but rather that the functionality of a hierarchical block is defined by a plurality of blocks in a subordinate level. Alternatively, it may contain code in a higher-level programming language, in particular a dynamic language intended for mathematical programming, that realizes the block's functionality. Multiple blocks may be connected by signals for the exchange of data. For example, an initial block may receive a signal of type single as input signal, may modify the signal e.g. by adding a constant and may send an output signal of type double to a further block. The further block could be considered downstream of the initial block because the blocks are connected by a signal path so that data flows from the initial block to the further block.

The production code generator PCG allows for creating production code from one or more blocks in a block diagram. Production code may be optimized for readability, traceability, safety, low-energy consumption, execution speed and/or memory requirements. The code generator can provide a user interface for setting a plurality of options for adapting the customization of the generated code. Customization options may include target-specific optimizations for the microcontroller of the embedded system and enforcing compliance of the generated code to a specific standard, such as the MISRA C guidelines. An exemplary production code generator PCG is TargetLink of dSPACE.

The data definition tool DDT provides a local or remote database for storing definitions and parameters as well as an application-programming interface for automatic exchange of the data between different software components. The term “database” can be understood in a broad sense, so that a file with a tree structure may be considered a local database. A data definition tool allows for a clean separation of the model of the dynamic system given in the block diagram from implementation-specific details stored in the database. When a complex model, in particular a large software component, is structured in different sub-models, in particular different subcomponents, data in different sub-models may be linked. By storing corresponding information in the data definition tool, these dependencies may be automatically resolved. Additionally, by exchanging data with the architecture definition tool, the data definition tool DDT can be used as part of a higher-level tool chain, for example, to generate product code compliant to the AUTOSAR standard. A data definition tool can be TargetLink Data Dictionary of dSPACE.

Other software components such as a production code compiler PCO may be installed on the computer. These software components may be interfaced to each other and/or the technical computing environment using standard mechanisms of the underlying operating system OS. The compiler PCO may generate an executable for the microprocessor of the PC, it may generate an object code for the microcontroller of the embedded system, or it may synthesize a bitstream for configuring a programmable logic device.

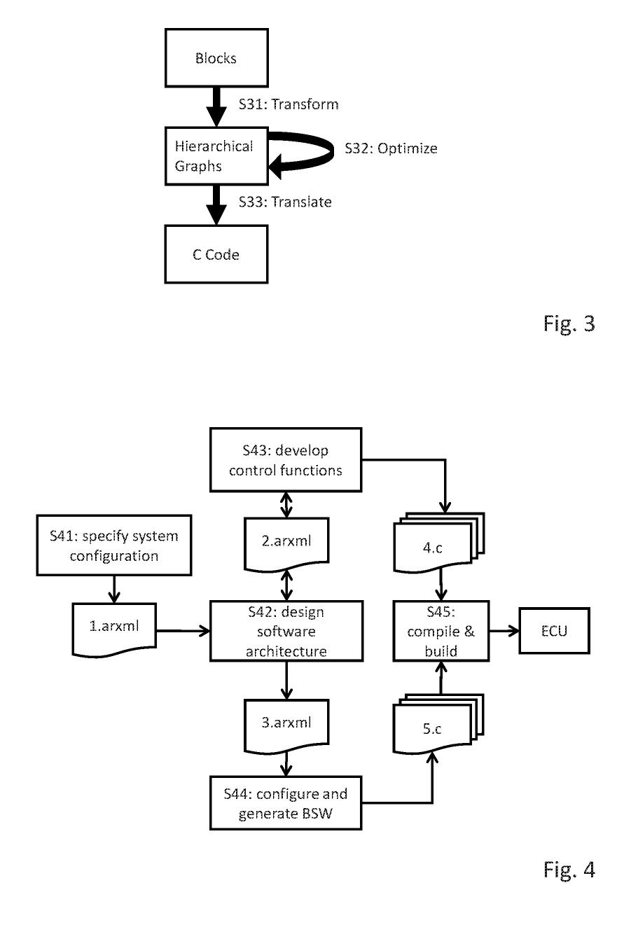

FIG. 3 illustrates an exemplary embodiment of the generation of production code from one or more blocks of a function model (block diagram). The following steps can be carried out by a microprocessor on the host computer; alternatively, a client server setup may be used so that computationally expensive steps are carried on a remote server containing a plurality of microprocessors.

In a first step S31, the selected one or more blocks (or, if selected, the entire block diagram) and related input data are transformed to an intermediate representation such as one or more hierarchical graphs. These hierarchical graphs may in particular comprise a data flow graph, a control flow graph and/or a tree structure. Related input data may e.g. be extracted from a database associated with the block diagram. This may encompass situations where elements of the block diagram are created based on information from a data definition tool, or where settings relevant for the production code generation are retrieved from the data definition tool.

In a second step S32, the hierarchical graphs are optimized in order to reduce the number of variables required and/or the number of operations or instructions to be carried out. This optimization may comprise a plurality of intermediate steps on further intermediate representations between block level and production code level. In each step, an initial set of hierarchical graphs or an intermediate language is converted to a modified set of hierarchical graphs or an intermediate language while applying one or more optimization rules. A number of strategies such as constant folding or elimination of dead code may be applied during optimization.

In a third step S33, the optimized intermediate representations such as optimized hierarchical graphs are translated to code in a high-level or low-level programming language, for example, C code. The code may be further optimized in this step and restricted to a subset of the linear or parallel programming language, the control and dataflow structures may be restricted to precisely specified variants, the scope of functions and data may be restricted according to accurately specified rules. Alternatively or in addition, additional information may be added to the code, e.g. in the form of comments, to enhance readability or help in debugging the code.

During or after the code generation, information on the current block diagram or the code generation, especially results of the code generation, may again be stored in the data definition tool. This information may e.g. be used to initialize the simulation engine, to influence a compilation process with a production code compiler, or to export production code information for use in other tools/process, like e.g. calibration and measurement information in ASAP2 format or AUTOSAR XML information.

In alternative embodiments, hardware-level code or a configuration for a programmable hardware device may be created from the blocks describing the control program.

FIG. 4 displays an exemplary diagram of a method for creating the firmware of an ECU.

In step S41 (specify system configuration) the hardware for execution of the one or more control programs is specified. While the system configuration in principle may comprise multiple ECUs, for simplicity the exemplary system described here may comprise only one ECU running one or more software components. When a different tool is used for specifying the system configuration than for defining the software architecture, the system configuration is exported by creating an ARXML file (1.arxml). Especially for an integrated architecture definition tool, system data and software information may be stored in a dedicated database or in a proprietary file format.

In step S42 (design software architecture), the software architecture of the software component is defined in the architecture definition tool ADT. The software architecture is exported by creating an ARXML file (2.arxml). A development process may comprise multiple repetitions of steps S42 and S43, also called round-trips. When the software architecture is defined and the behavior is modeled, the software architecture is exported in an ARXML file (3.arxml) for creating a basic software of the ECU. This file may comprise one or more sections different from those in the file generated in step S41, containing for instance specification data of a microcontroller of the ECU.

In step S43 (develop control functions), the defined architecture of a software component is imported in the behavior-modeling tool BMT and a functionality of the software component is edited in a graphical model editor; prior to a manual modeling, a framework model may be automatically generated based on the imported architecture information. The ARXML file comprises a plurality of sections; one section defines the interface of the software component, which may comprise input ports and output ports for receiving and sending signals, global variables, as well as sender- and receiver-interfaces. One section of the ARXML file concerns the implementation, i.e. the source code files generated by the behavior-modeling tool BMT; this section is initially empty and will be added when reimporting an ARXML file of the software architecture from the behavior-modeling tool. A simplified schematic of an ARXML file is shown below in listing 1.

In step S44 (configure and generate BSW), a basic software (BSW) is configured that will provide functions and interfaces to the software component. The basic software is adapted to the specific ECU hardware and can be considered a custom-made operating system for the ECU. In addition, a runtime environment may be created as a middleware between basic software and software component; the runtime environment may provide messaging services for exchanging data between different software components or runnable entities. Creating the basic software may be performed by the architecture definition tool or by a dedicated basic software generator.

In step S45 (compile & build), the source code files (4.c) of the software component and the source code files (5.c) of the basic software are compiled by a (cross-)compiler adapted to the target hardware platform (the processor/microcontroller of the ECU) and linked to produce a binary executable file. The binary executable file may be written on a non-volatile memory of the electronic control unit (ECU).

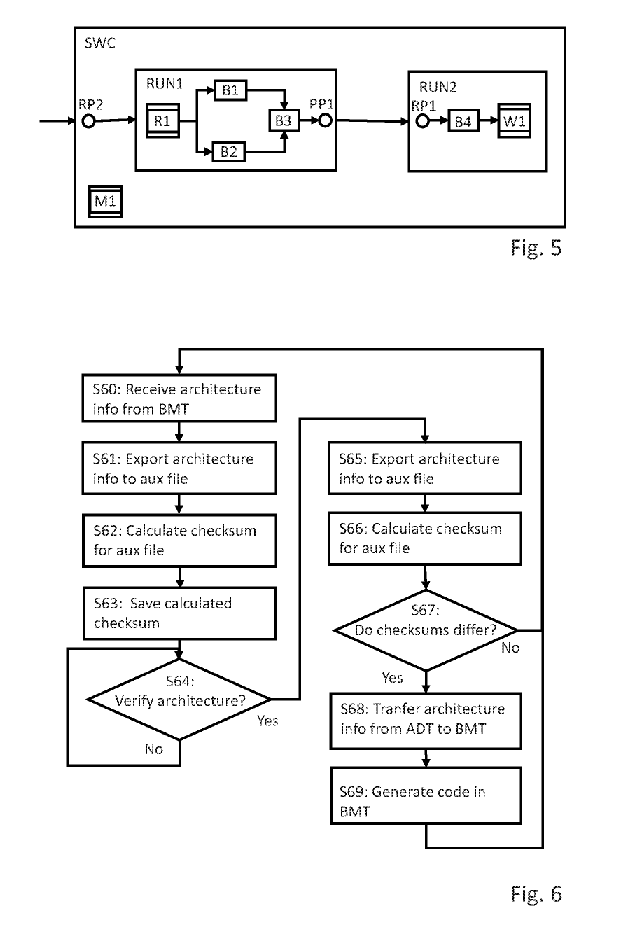

FIG. 5 displays an exemplary function model (block diagram) of a software component as designed in the model editor MOD of the behavior-modeling tool BMT.

The shown software component SWC comprises two subcomponents that are separately runnable entities, a first runnable RUN1 and a second runnable RUN2; additionally, it comprises a data store memory M1 and an input port RP2 for receiving data from another software component.

Runnable R1 comprises a read block R1 for reading from data store memory M1, three functional block B1, B2, B3 that may be hierarchical blocks, and an output port PP1. The blocks are connected by signals with arrows indicating the data flow.

Runnable R2 comprises an input port RP1, a functional block B4 and a rite block W1 for writing to the data store memory M1. The input port RP1 of RUN2 is connected to the output port PP1 of RUN1.

From the block diagram, an AUTOSAR XML file of the architecture may be generated; in the following listing 1, the general format of an ARXML-file is shown.

Listing 1:

| | |
|---|---|
| <AUTOSAR | ...> |

```
<AR-PACKAGES>
  <AR-PACKAGE>
    <SHORT-NAME>Name1</SHORT-NAME>
    <ELEMENTS>
      <APPLICATION-SW-COMPONENT-TYPE>
        <SHORT-NAME>SWC</SHORT-NAME>
        <PORTS>
            <R-PORT-PROTOTYPE>
              <SHORT-NAME>RP2</SHORT-NAME>
            </R-PORT-PROTOTYPE>
          </PORTS>
          <INTERNAL-BEHAVIORS>
            <SWC-INTERNAL-BEHAVIOR>
                <SHORT-NAME>Name4</SHORT-NAME>
                <RUNNABLES>
                  <RUNNABLE-ENTITY>
                    <SHORT-NAME>RUN1</SHORT-NAME>
                  </RUNNABLE-ENTITY>
                  <RUNNABLE-ENTITY>
                    <SHORT-NAME>RUN2</SHORT-NAME>
                  </RUNNABLE-ENTITY>
                </RUNNABLES>
            </SWC-INTERNAL-BEHAVIOR>
          </INTERNAL-BEHAVIORS>
        </APPLICATION-SW-COMPONENT-TYPE>
      </ELEMENTS>
    </AR-PACKAGE>
  </AR-PACKAGES>
</AUTOSAR>
```

When source code is generated, an implementation section needs to be added or updated in the ARXML file, as discussed above in connection with FIG. 4. The implementation section may comprise the names of and paths to the different code files.

FIG. 6 illustrates the steps performed according to the inventive method for detecting changes to the design of a software component. The method may be performed by a processor of a host computer running a control tool.

In step S60 (Receive architecture info from BMT), an ARXML file comprising the architecture definition of a software component is received from a behavior-modeling tool BMT.

In step S61 (Export architecture info to aux file), the current architecture of the software component is exported to a first auxiliary ARXML file. Exporting the file may comprise following selected references and/or filtering the retrieved elements according to one or more criteria.

In step S62 (Calculate checksum for aux file), a first checksum for the elements contained in the first auxiliary file is calculated. The calculation may be based on a standard function, such as a MD5 hash or a SHA-1 hash. After calculating the checksum, the first auxiliary file may be deleted.

In step S63 (save calculated checksum), the first checksum calculated based on the received architecture info is saved, and it may be stored in a predefined element of the ARXML file received from the behavior-modeling tool. The control tool may comprise a dedicated variable for storing the first checksum.

In step S64 (Verify architecture?) the processor determines if a request for verifying the absence of changes to the architecture has been received. Such a request may be received from the user via a user interface, or it may be triggered by special conditions, such as a changed version number of the architecture model, or periodically based on a timer. When no request is received, each time a user performs a data exchange between behavior modeling tool and architecture definition tool, execution may resume at step S60 (the first checksum may be calculated for each roundtrip).

Once a request for verifying an unchanged architecture has been received, the processor exports in step S65 (Export architecture info to aux file) the current architecture of the software component to a second auxiliary ARXML file. Exporting the file may comprise following selected references and/or filtering the retrieved elements according to one or more criteria. In step S66 (Calculate checksum for aux file), a second checksum for the elements contained in the second auxiliary file is calculated.

In step S67 (Do checksums differ?) the processor determines if the second checksum differs from the first checksum. For no difference, i.e. an unchanged architecture definition, the algorithm may resume the next time a user performs a data exchange between behavior modeling tool and architecture definition tool.

In case a difference is detected, the processor can indicate the presence of the difference to the user. Alternatively or additionally, a new roundtrip may be performed. The architecture information is transferred from the architecture definition tool to the behavior modeling tool in step S68 (Transfer architecture info from ADT to BMT), and a new code generation in the behavior modeling tool is started in step S69 (Generate code in BMT). The function model and generated code can be saved in a file system of the host computer or in a database. The algorithm may resume in step S60 the next time a user performs a data exchange between behavior modeling tool and architecture definition tool.

Those skilled in the art will appreciate that the order of at least some of the steps of the inventive method may be changed without departing from the scope of the claimed invention. While the present invention has been described with respect to a limited number of embodiments, those skilled in the art will appreciate numerous modifications and variations therefrom. It is intended that the appended claims cover all such modifications and variations as fall within the true spirit and scope of the present invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method comprising:
generating a software component for an electronic control unit, the method being executed by at least one processor in a computer system, the software on the computer system comprising an architecture definition tool and a behavior-modeling tool, the architecture definition tool being adapted to define an architecture of the software component, architecture information comprising a declaration of one or more subcomponents and one or more interfaces, the architecture definition tool being adapted to export and import architecture information, the behavior modeling tool being adapted to generate source code for the software component based on a function model comprising a plurality of interconnected blocks, the behavior-modeling tool additionally being adapted to import and export architecture information, wherein the behavior-modeling tool creates or updates a model framework for the function model based on the architecture information;
receiving architecture information from the behavior-modeling tool;
exporting architecture information from the architecture definition tool in a first auxiliary file;
calculating a first checksum for the first auxiliary file'
saving the first checksum;
receiving a request to check for changes in the architecture;
exporting architecture information from the architecture definition tool in a second auxiliary file;
calculating a second checksum for the auxiliary file;
comparing the second checksum to the first checksum;
indicating, in case of a difference between the second checksum and the first checksum, a presence of changes to the user and/or transferring architecture information from the architecture definition tool to the behavior-modeling tool; and
generating code in the behavior-modeling tool.

2. The method of claim 1, wherein transferring architecture information from the architecture definition tool to the behavior modeling tool comprises creating an XML file or an AUTOSAR ARXML file.

3. The method of claim 1, wherein receiving architecture information from the behavior modeling tool comprises receiving an XML file or an AUTOSAR ARXML file, wherein the received XML comprises a section with variable information including data type, scaling or range.

4. The method of claim 1, wherein exporting the architecture information from the architecture definition tool comprises filtering the architecture information.

5. The method of claim 4, wherein filtering the architecture information comprises receiving a selection of elements to ignore.

6. The method of claim 1, wherein the steps of exporting the architecture information from the architecture definition tool in a first auxiliary file and calculating a first checksum for the first auxiliary file are performed after each transfer of architecture information from the behavior modeling tool to the architecture definition tool.

7. The method of claim 1, wherein receiving a request to check for changes in the architecture comprises receiving a command by a user via a user interface.

8. The method of claim 1, wherein an architecture definition of the electronic control unit comprises multiple software components, and wherein a checksum is calculated separately for each software component, so that when checking for changes in the architecture separate comparisons to previous checksums are made for each software component.

9. A computer system comprising:
at least one host computer, the at least one host computer comprising a processor, a random access memory, a graphics controller connected to a display, a serial interface connected to at least one human input device, and a nonvolatile memory,
wherein the nonvolatile memory comprises instructions that, when executed by the processor, cause the host computer to carry out the method according to claim 1.

10. A non-transitory computer readable medium containing instructions that, when executed by a processor of a computer system, cause the computer system to carry out the method according to claim 1
